(19) United States
(12) Patent Application Publication
(10) Pub. No.: US 2007/0262277 A1
(43) Pub. Date: Nov. 15, 2007

(54) Single Use Diaphragm Valve Body

(75) Inventors: Paul Martyn Williams, Torfaen (GB); Kenneth L. Bibbo, Freehold, NJ (US)

Correspondence Address: HARNESS, DICKEY & PIERCE, P.L.C., P.O. BOX 828, BLOOMFIELD HILLS, MI, 48303, US

(73) Assignees: Crane Process Flow Technologies Limited, Cwmbran, Gwent (GB); Alfa Laval Biokinetics Inc., Philadelphia, PA (US)

(21) Appl. No.: 10/578,815

(22) PCT Filed: Oct. 27, 2004
(86) PCT No.: PCT/GB04/04535

§ 371 Date: Mar. 21, 2007

(30) Foreign Application Priority Data
Nov. 4, 2003 (GB) 0325714.4
Nov. 4, 2003 (GB) 0325715.1

(51) Int. Cl. F16K 7/04

(52) U.S. Cl. 251/7

(57) ABSTRACT

A diaphragm valve (1) comprising a valve body (2); a diaphragm (12) which is sealed to the valve body (2) to define a flow passage (9) which extends between an inlet port (7) and an outlet port (8), both defined by the valve body (2); and an operating mechanism secured to the valve body (2) for moving the diaphragm (12) into sealing engagement with a seat (11) provided on the valve body (2) in order to close the flow passage (9) to fluid flow. The valve body (2) and diaphragm (12) are formed as a disposable assembly having a relatively less flexible region which forms a valve seat (11) and a relatively more flexible region (12) which forms the diaphragm which may be forced into engagement with the valve seat (11) to close the flow passage (9) to fluid flow, and a housing (3) is provided for mechanically supporting the region of the valve body in which the seat area is defined.

This invention relates to a diaphragm valve, and more particularly to a diaphragm valve having a body which is disposable.

A diaphragm valve comprises a valve body having a diaphragm opening to which a diaphragm is sealed. The valve body and diaphragm together define a flow passage which extends between an inlet port and an outlet port, both defined by the valve body. An operating mechanism is secured to the valve body for moving the diaphragm into sealing engagement with a seat provided on the valve body in order to close the flow passage to fluid flow.

Diaphragm valves have gained wide acceptance in many industries. One reason for the success of diaphragm valves in many industries is the fact that the line content is totally contained within the flow passage defined by the valve body and the diaphragm, and accordingly does not come into contact with any components of the valve other than the diaphragm and this body. This renders diaphragm valves particularly suitable for handling hazardous materials, or for use in applications where high levels of purity are required. For this reason, diaphragm valves have wide acceptance in the biotechnology industry.

It is of critical importance in the biotechnology industry in particular that process equipment can be thoroughly cleaned. Although existing diaphragm valves do admit to thorough cleaning by use of cleaning chemicals and/or steam, ensuring absolute cleanliness with existing diaphragm valves is difficult. It may, for example, be necessary, after initial cleaning, to dis-assemble a diaphragm valves in order to carry out a validity check on the sterility of the system. Such cleaning processes are both time consuming and subject to operator error. Even if, in a particular application, dis-assembly of the valve after initial cleaning is not considered to be necessary, the initial cleaning phase using cleaning chemicals and/or steam cleaning must be carried out thoroughly to achieve a high level of cleanliness. Accordingly, even if valve dis-assembly is not necessary high quality cleaning procedures associated with process plant incorporating diaphragm valves are time consuming (and thus costly) and subject to operator error.

Accordingly, the present invention proposes a diaphragm valve in which the body and the diaphragm are “disposable”. With such a valve, the valve in its entirety may be removed from a process line and the valve body and diaphragm replaced with a new valve body and diaphragms. Alternatively, only the valve body and diaphragm need be removed and replaced, whilst the remaining components of the valve are left in situ. Such replacement may take place instead of thorough cleaning of the valve or at specified intervals in order to prevent the build-up of contaminants within the valve.

Because it is a characteristic of diaphragm valves that the operating mechanism (compressor and actuator) does not come into contact with the line fluid it should not be necessary to dispose of these components when the body itself is disposed of.

Accordingly, it is the primary object of the present invention to provide a diaphragm valve in which the diaphragm and valve body may be disposed of and in which other components of the valve may be re-used in combination with a replacement valve body and diaphragm.

At first sight, the object of the present invention can be achieved simply by replacing a conventional valve body (which is typically of polished forged or cast stainless steel) with a moulded plastics valve body of the same profile. However, this is not possible because the mechanical characteristics of conventional metal valve bodies cannot be reproduced using plastics materials. In particular, the conventional arrangement whereby the closure diaphragm is sealed to the body by clamping the periphery of the diaphragm between respective flanges provided on the body and on the actuating mechanism is not possible if the body is formed of plastics material, in particular flexible plastics material.

In accordance with a first aspect of the present invention a diaphragm valve comprising: a valve body; a diaphragm which is sealed to the valve body to define a flow passage which extends between an inlet port and an outlet port, both defined by the valve body; and operating mechanism secured to the valve body for moving the diaphragm into sealing engagement with a seat provided on the valve body in order to close the flow passage to fluid flow, is characterised in that the valve body and diaphragm are formed as a disposable assembly having a relatively less flexible region which forms a valve seat and a relatively more flexible region which forms a diaphragm which may be forced into engagement with the valve seat to close the flow passage to fluid flow, and a housing is provided for mechanically supporting the region of the valve body in which the seat area is defined.

The diaphragm valve of the present invention replaces the three main components of the conventional diaphragm valve, namely the body, the diaphragm and the operating mechanism, with three other fundamental components, namely a combined body/diaphragm component, the operating mechanism and a support for the combined body/diaphragm. This fundamental revision of the nature of the components enables the design of a disposable body/diaphragm component to be optimised for production and fluid flow characteristics even if this optimisation results in a body the mechanical strength of which would not be sufficient to withstand the forces conventionally applied to diaphragm valve bodies.

In accordance with a second aspect of the present invention a diaphragm valve comprising: a valve body having a diaphragm opening surrounded by a sealing surface; a diaphragm which is sealed to the sealing surface to define with the valve body a flow passage which extends between an inlet port and an outlet port, both defined by the valve body; and operating mechanism secured to the valve body for moving the diaphragm into sealing engagement with a seat provided on the valve body in order to close the flow passage to fluid flow, is characterised in that the sealing surface of the valve body is surrounded by a wall which is upstanding from the outer periphery of the sealing surface to define a recess in which the periphery of the diaphragm is, in use, located, and a diaphragm retaining member is secured to the valve body, the diaphragm retaining member including a projection which extends into the recess to engage the diaphragm and compress it between the projection and the sealing surface of the valve body.

The diaphragm locating arrangement in accordance with the second aspect of the present invention substantially obviates the problems of diaphragm mounting which would exist if a conventionally shaped valve body were formed of plastics material.

The diaphragm body and diaphragm may be pre-assembled and supplied as a single assembly for insertion by a user in place of a previously used assembly. The diaphragm retaining member may similarly be supplied as part of the pre-assembled combination. Alternatively, the diaphragm retaining member may be part of an operating mechanism which is releasably secured to the body/diaphragm assembly at the time of installation of the new body/diaphragm assembly.

The invention will be better understood from the following description of preferred embodiments thereof, given by way of example only, reference being had to the accompanying drawings wherein:

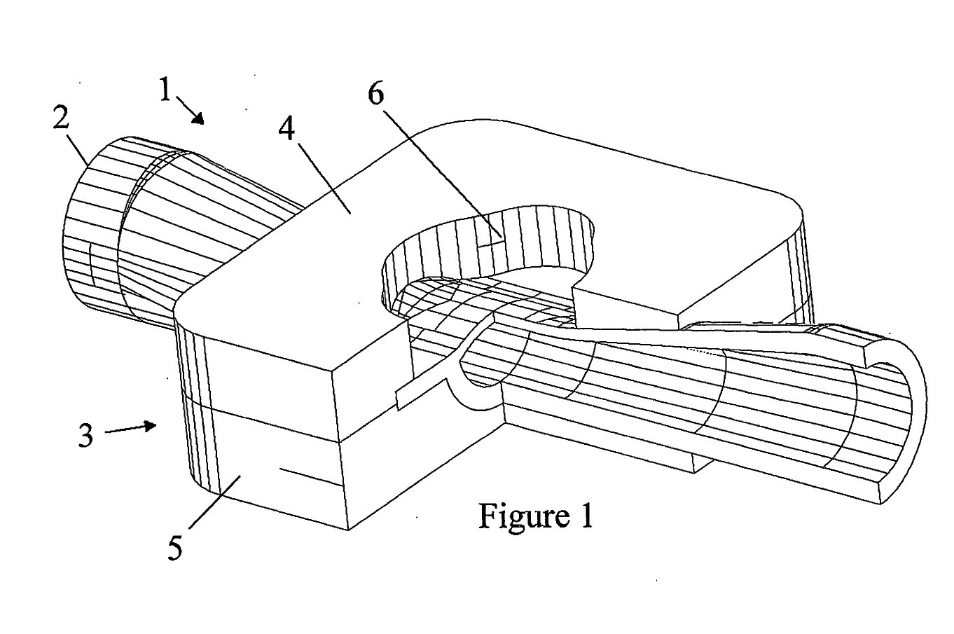

FIG. 1 illustrates a diaphragm body/diaphragm component and support of a first embodiment of the invention;

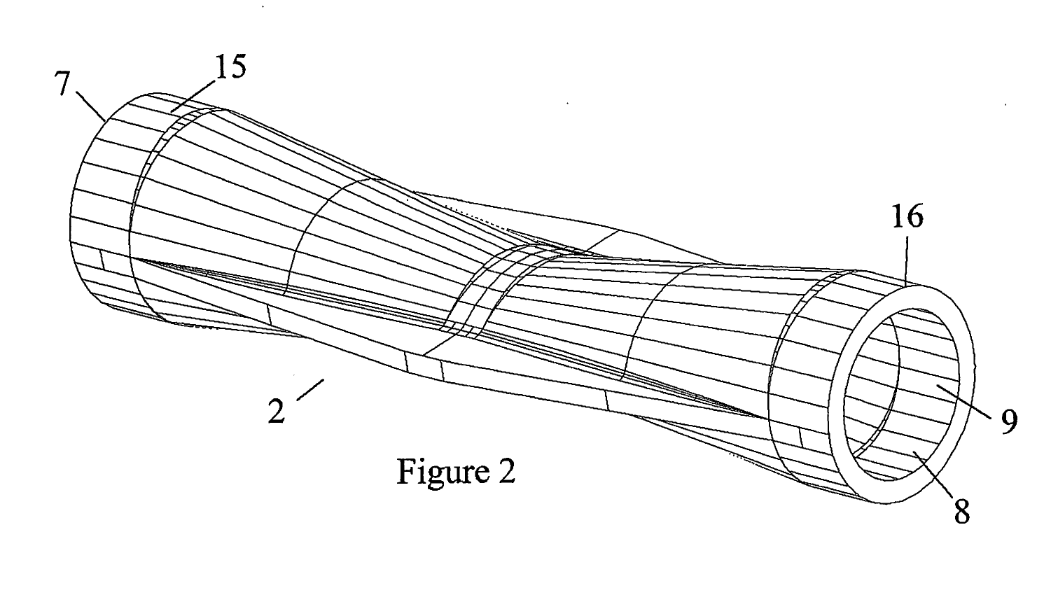

FIGS. 2, 3 and 4 show respectively an isometric view, a transverse cross-section, and a longitudinal cross-section of the valve body/diaphragm component of FIG. 1;

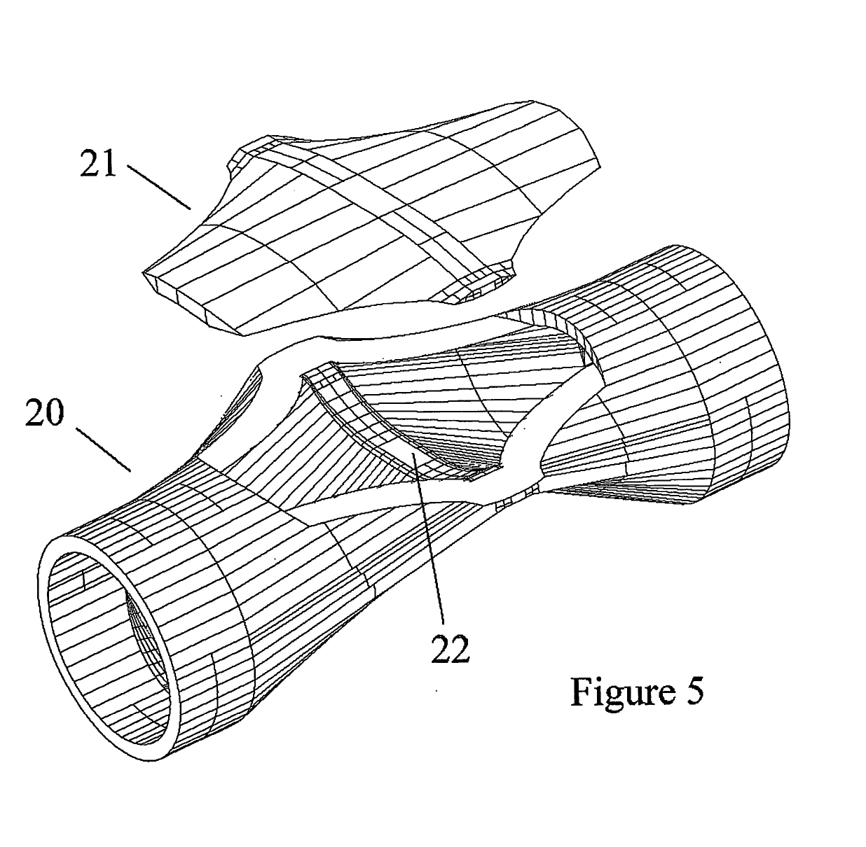

FIG. 5 illustrates an alternative valve body/diaphragm component;

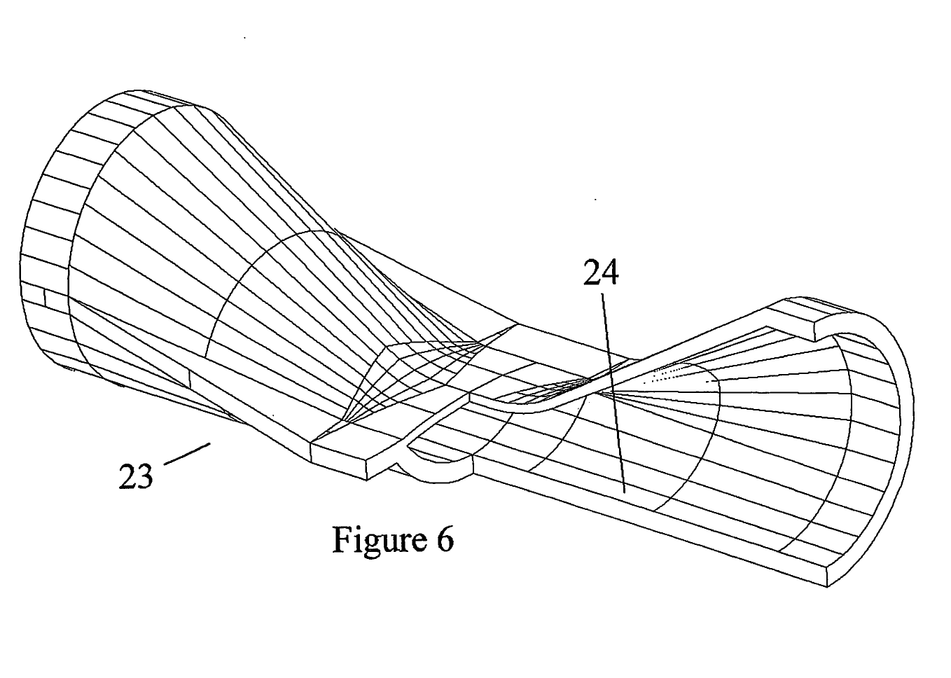

FIG. 6 illustrates an alternative valve body/diaphragm profiled to provide self-draining characteristics;

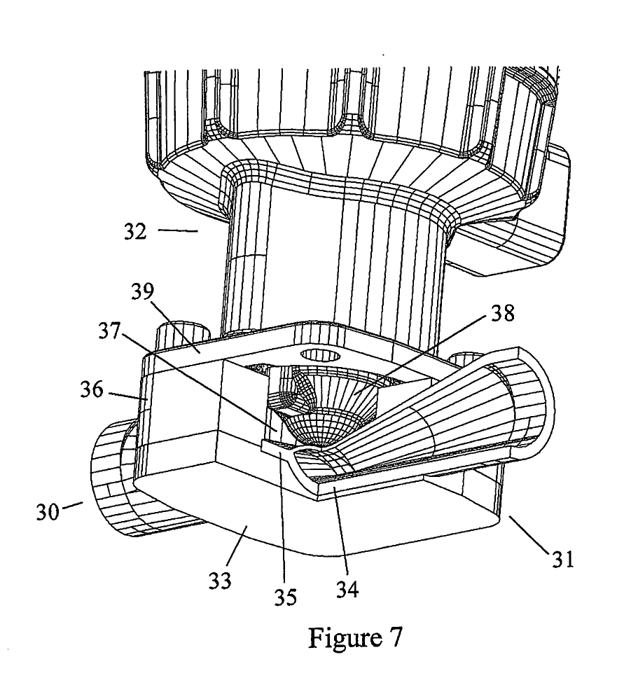

FIG. 7 illustrates the components of FIG. 1 secured to an operating mechanism;

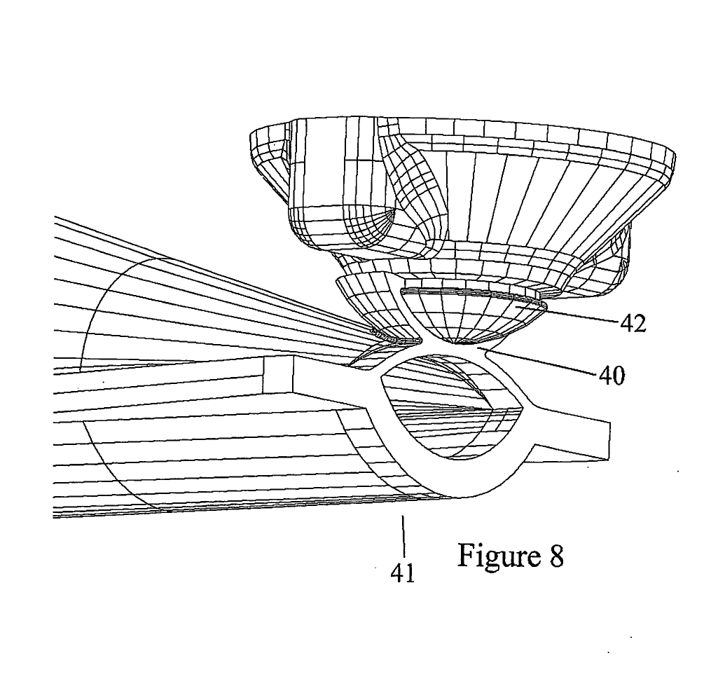

FIG. 8 illustrates a modified embodiment of the invention in which means are provided for forming a mechanical connection between a flexible portion of the body/diaphragm component and a compressor;

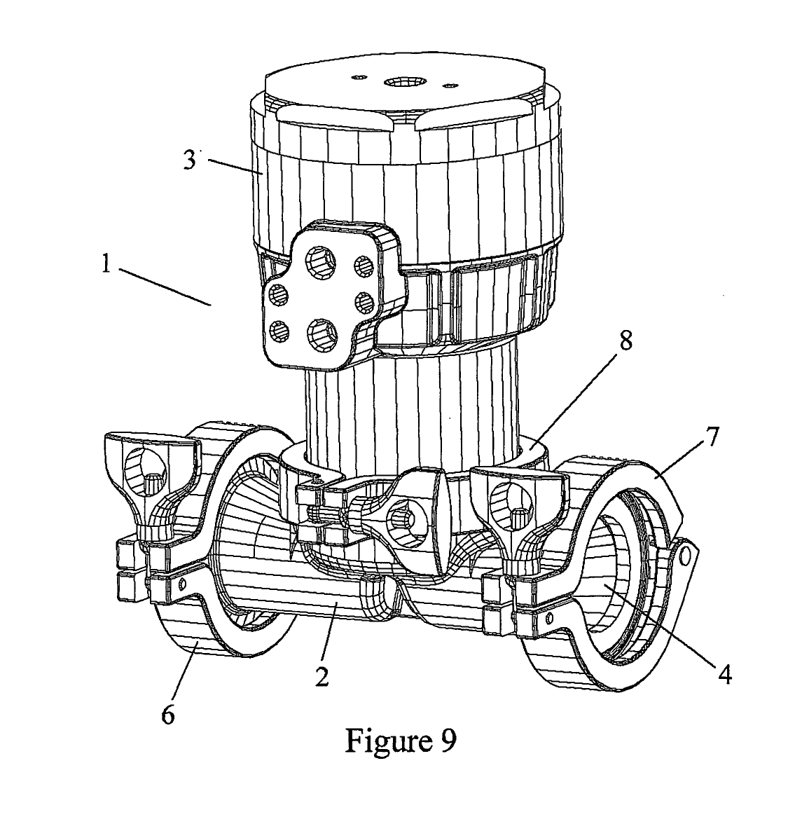

FIG. 9 shows schematically another disposable diaphragm valve embodiment of the present invention in the form of a diaphragm valve having a reusable operating mechanism and a disposable body and diaphragm assembly;

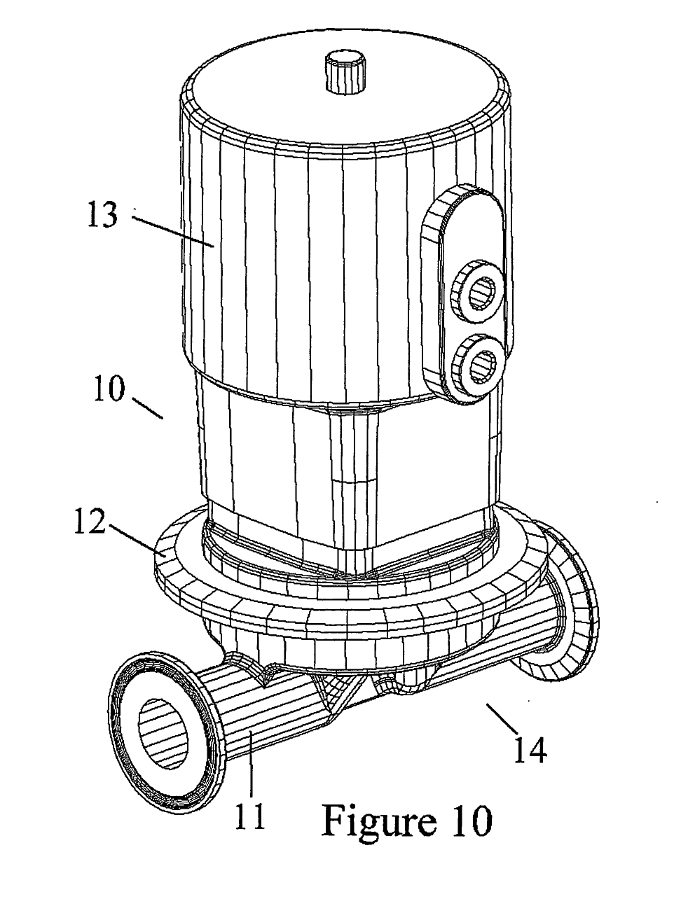

FIG. 10 illustrates an alternative embodiment of the disposable diaphragm valve of FIG. 9 in which a disposable assembly comprising a valve body, diaphragm and diaphragm retaining member is attached to a reusable operating mechanism;

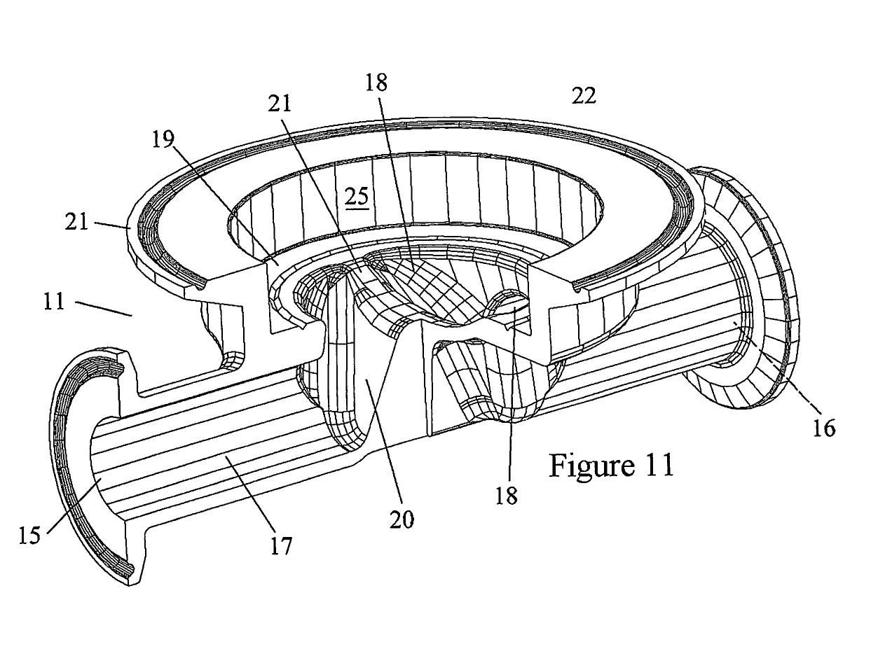

FIG. 11 illustrates the valve body of the embodiment of FIG. 10;

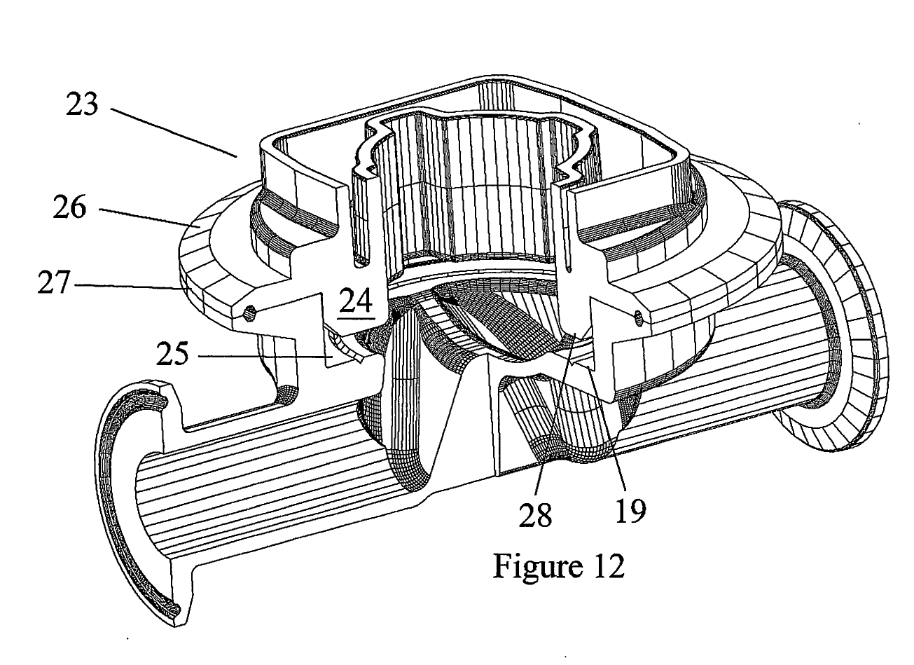

FIG. 12 illustrates the valve body and diaphragm retaining member of the embodiment of FIG. 10;

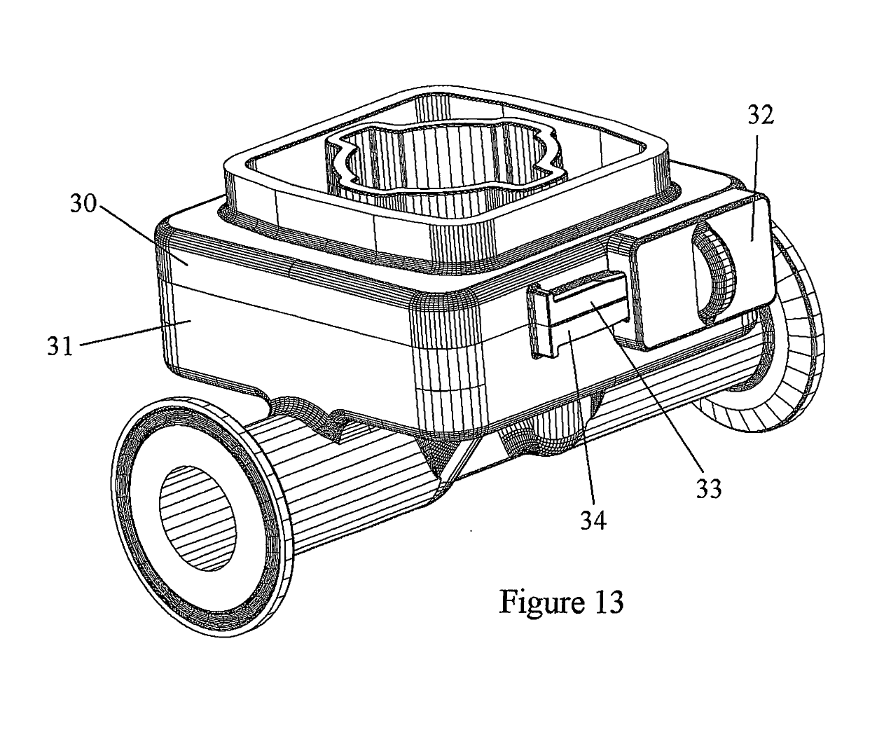

FIGS. 13-15 illustrate alternative arrangements for securing a diaphragm retaining member to a valve body;

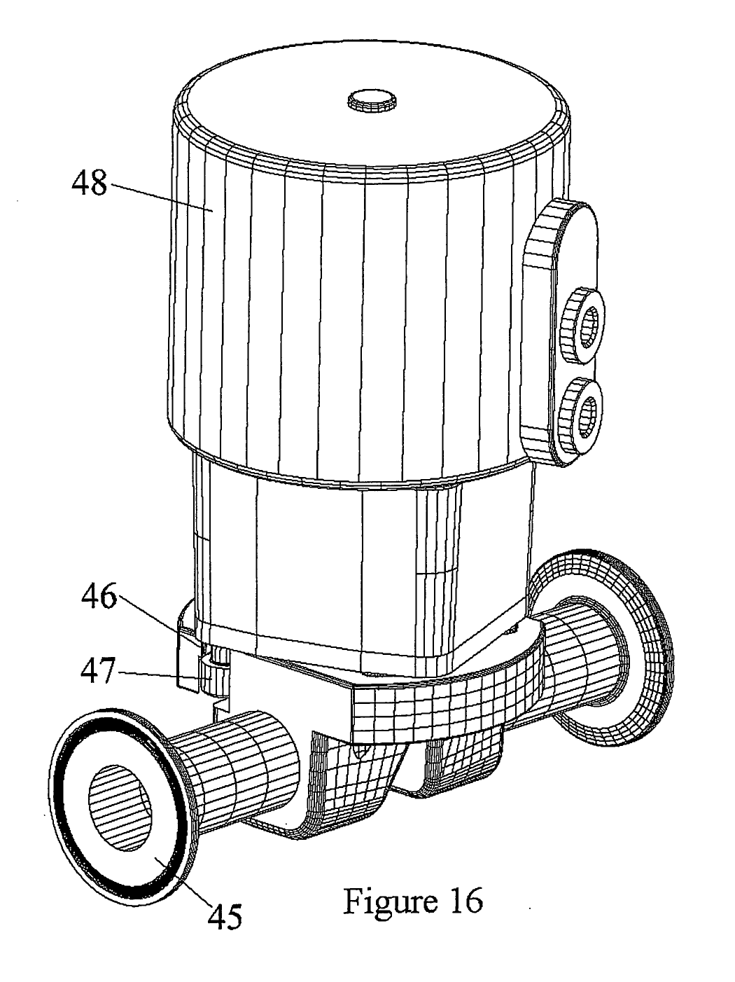

FIG. 16 illustrates an arrangement for securing an operating mechanism directly to a valve body, and

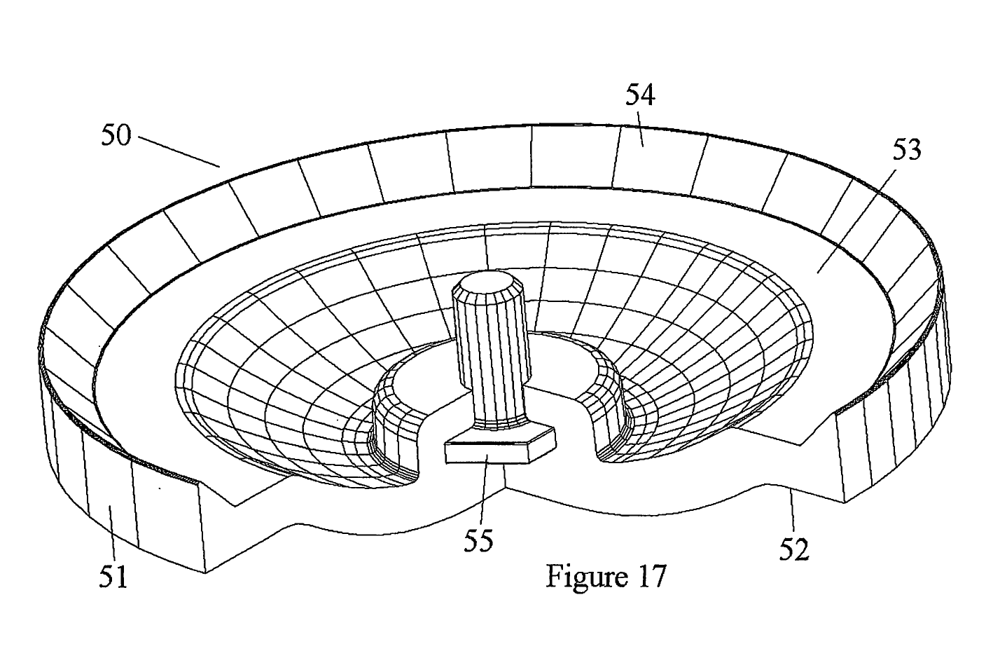

FIG. 17 illustrates a diaphragm for use in the preceding embodiments of the invention.

Referring firstly to FIG. 1 there is illustrated a diaphragm valve 1 from which the operating mechanism has been removed in the interests of clarity. The remaining components of the valve comprise a combined body and diaphragm member 2 and a support 3 formed by an upper support member 4 and a lower support member 5. The upper support member 4 defines an aperture 6 in which, in use, a diaphragm compressor is located. Means (not shown) are in practice provided for securing the operating mechanism to the support 3.

The body and diaphragm member 2 is illustrated in greater detail in FIGS. 2-4. The member 2 is moulded from a synthetic material, for example a synthetic thermo-plastic material. The material may be un-reinforced or reinforced by fibre or other reinforcing materials depending on the circumstances and design in question. It will be seen that the member 2 defines inlet and outlet ports 7, 8 respectively, and a flow passage 9 which connects the inlet and outlet ports. As illustrated, the member 2 is symmetrical about a transverse plane of symmetry and accordingly either of the ports 7, 8 may function as an inlet port whilst the other port functions as an outlet port.

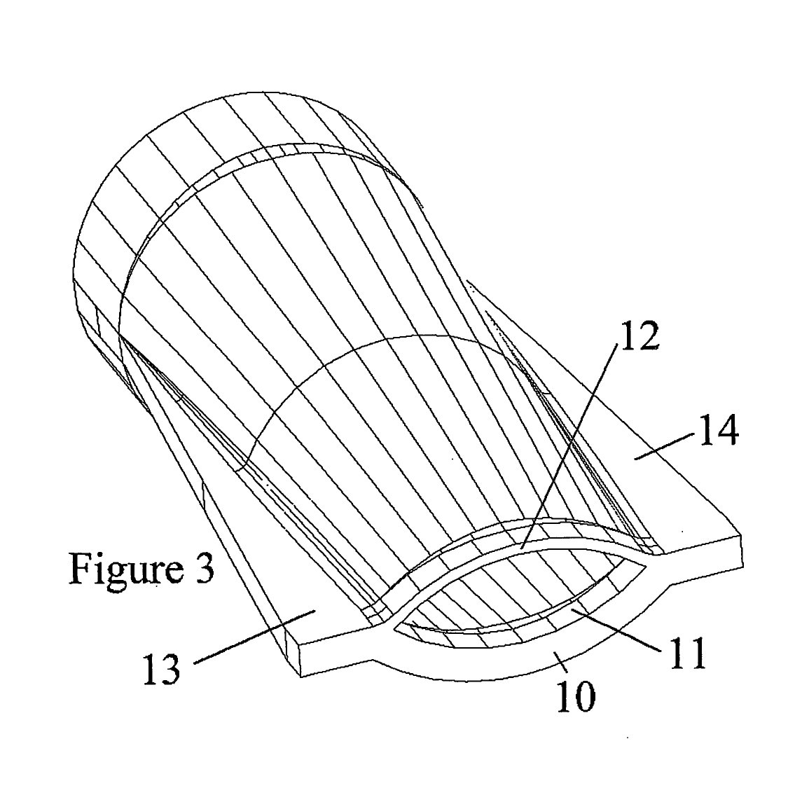

A transverse cross-section in the central region of the member 2 is illustrated in FIG. 3. In this transverse region the body includes a relatively thick lower portion 10 which defines, on the upper surface thereof, a valve seat 11. The valve seat 11 maybe constituted by a portion of a generally smooth flow passage, or may be formed by the upper surface of a weir moulded into the flow passage. Opposite the seat 11 is a relatively flexible portion 12 of the body which can be moved, by a suitable operating mechanism into sealing engagement with the seat 11 to close the flow passage 9 to fluid flow. The relatively flexible nature of the region 12 is achieved by a combination of the profile of the member 2 at this region and by a relatively thin section of material at this region. Similarly, the relatively rigid region 10 is formed by a relatively thick section of material and/or reinforcement provided in this region.

It will be noted that wings 13, 14 extend laterally outwardly from the remaining portions of the member 2. The wings at their widest at the central portion at which the cross-section of FIG. 3 is taken and reduced in lateral extent towards the opposite ends of the member 2, eventually blending into the profile of the member 2 adjacent the end regions 15, 16 of the body. The purpose of the wings 13, 14 is to provide additional strengthening of the valve body, particularly in the region of the cross-section illustrated in FIG. 3.

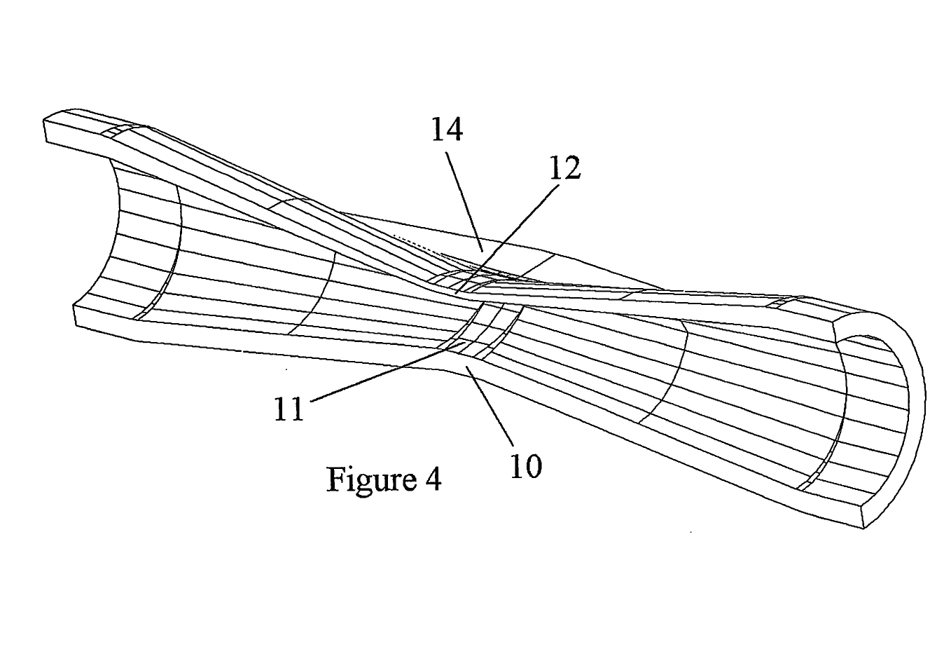

The thin cross-section of the region 12 blends, in the longitudinal direction, into the full cross-section of the wall of the body, reaching the full cross-section by the end regions 15 and 16, as illustrated in the longitudinal cross-section of FIG. 4.

The required contrast between the relatively rigid region 10 and the relatively flexible region 12 may be achieved by use only of the shaping of these regions, and in particular the thickness of material in these regions, or may be achieved by other means, for example the inclusion of reinforcing material within the relatively rigid regions and/or by differences in the plastics material utilised in the respective regions. It may, for example, be possible to mould a unitary body in which the relatively flexible region 12 is formed from a different polymer or different grade of the same polymer as that used for the relatively rigid regions. This technique may be used in association with the variable wall thick technique referred to above. The important characteristic is that the member 2 defines a relatively rigid region and a relatively flexible region which can be brought into engagement with the rigid region to interrupt fluid flow through the flow passage 9.

The member 2 illustrated in FIGS. 2-4 may be moulded as a single unitary moulding by use of suitable mould and core tools. In the alternative, the member may be formed by two components, one of which has the form illustrated in FIG. 4 and the other of which is a mirror image of that component about the longitudinal plane of the section of FIG. 4. Two such components can be moulded separately and joined together after moulding by a welding process.

Turning now to FIG. 5 an alternative approach to the design and construction of a combined body and diaphragm member is illustrated. In this case, the body 20 is moulded from one synthetic material and the diaphragm 21 is moulded from a different material which is, nonetheless, compatible with the material of the body 20 so that the two components may be welded together to form a unitary body and diaphragm member. The advantage of the FIG. 5 arrangement is that the materials from which the body 20 and diaphragm 21 are made may, to an extent, be optimised in light of the respective function these components are to perform, thereby providing a relatively rigid seat area and a relatively flexible diaphragm area. In practice, after the body 20 and diaphragm 21 have been formed and united by an appropriate process the resultant combined member will be used in association with a support appropriately shaped to the profile of the combined member in order to provide the necessary mechanical support in the region of the valve seat 22.

Referring now to FIG. 6, an alternative form of combined body and diaphragm member 23 is illustrated. This design generally corresponds to that of the previous embodiments in that it may be a unitary moulding, an assembly of two substantially symmetrical moulded parts, or an assembly of two separate mouldings (body and diaphragm). In this case, however, the body is profiled to provide a substantially flat invert surface 24 so that the valve will have “self-draining” characteristics.

FIG. 7 illustrates a complete valve comprising a combined body and diaphragm member 30, a support 31, and an operating mechanism 32. The support 31 comprises a lower support member 33 which offers mechanical support for the relatively rigid portions 34 of the valve body and the wings 35 (only one of which is visible in FIG. 7) and an upper portion 36 which serves to locate the component relative to the support 31 and defines a cavity 37 in which the compressor 38 of the operating mechanism 32 is located. Suitable means (for example screws) are provided for attaching the upper part 36 of the support 31 to a flange 39 provided on the operating mechanism 32. The lower portion 33 of the support 31 is secured to the upper portion 36 of the support 31 by one or more releasable clamps. For example, the lower portion 33 may be secured to the upper portion 36 by means of a hinge along one edge and by means of a releasable over-centred toggle clamp along the opposite edge. With such an arrangement, the lower portion 33 can be readily separated from the upper portion 36 to permit removal of the body and diaphragm component 30 for appropriate disposal and replacement.

In the arrangement illustrated in FIG. 7 the compressor 38 abuts the flexible region of the body and diaphragm member 30, but no mechanical coupling is provided between these respective components. Accordingly, the valve of FIG. 7 would be incapable of opening against a sub-ambient pressure within the valve body. To avoid this problem an arrangement for mechanically coupling the flexible portion of the body and diaphragm member to the compressor may be provided. Such an arrangement is illustrated in FIG. 8. In this case, a cup 40 is moulded integrally with the body and diaphragm member 41 in the flexible region thereof and is, in use, secured by a snap-fit connection to a button 42 provided on the compressor. With such an arrangement the compressor can readily be coupled to and released from the diaphragm and body member 30.

In the above illustrated embodiments of the invention the body and diaphragm component is illustrated as having plain cylindrical ends. Such ends would, of course, require appropriate coupling to secure them into a pipework system. The exact form of the couplings will depend on the application and many such forms of couplings will be apparent to those skilled in the art.

In a particularly preferred embodiment of the invention arrangements are put in place to permanently mark each body and diaphragm assembly as it is placed within the support. Such means may, for example, comprise a knife blade provided on the support which cuts a notch or makes an incision in one of the wings of the body and diaphragm member. The object of this arrangement is to ensure that a previously used component will not accidentally be re-used.

Referring now to FIG. 9 there is shown a diaphragm valve 1 comprising a body 2 and an operating mechanism 3. As will be understood by those skilled in the art a diaphragm (not visible in FIG. 1) closes a diaphragm opening provided in the valve body 2 and is connected to a compressor which forms part of the operating mechanism 3. The compressor is acted upon by an actuator which also forms part of the operating mechanism 3 in order to move the diaphragm between a closed position in which it sealingly engages a seat provided in the valve body to close a flow passage 4 to fluid flow and an open position in which the flow passage is open to permit fluid to flow between an inlet port 5 located at one end of the valve body and an outlet port (not visible in FIG. 1) located at the opposite end of the valve body.

In the diaphragm valve of FIG. 1, the valve body 2 and diaphragm are disposable whilst the operating mechanism 3 is re-usable. To this end, quick release clamps 6 and 7 are provided for releasably securing the valve body to adjacent components in a pipework system and a releasable clamp 8 is provided for releasably securing the operating mechanism 3 to the valve body 2. The exact frequency with which the valve body 2 will be replaced in use will depend on the nature of the process in which the valve is used. Typically, in high purity applications in the biotechnology industry it is intended that the valve body 2 will be replaced each and every time that the system is cleaned. In other applications, however, replacement of the valve body may occur at specified time intervals, depending on the nature of the process in which the valve is utilised.

Referring now to FIG. 10 an alternative design of diaphragm valve 10 is illustrated. This design incorporates a disposable valve body 11 and a disposable diaphragm (not visible from FIG. 10). In this case the diaphragm is secured and sealed to the valve body by a diaphragm retaining member 12 which forms part of a disposable assembly 14 comprising the valve body 11, the diaphragm and the diaphragm retaining member 12. An operating mechanism 13 is releasably secured to the diaphragm retaining member 12 so that when the disposable assembly 14 is replaced, the operating mechanism 13 can be secured to a new assembly.

Referring now to FIG. 11, the valve body 11 of the valve of FIG. 10 is illustrated in greater detail. The valve body will be seen to define an inlet port 15 and an outlet port 16. The valve body illustrated is, in fact, symmetrical so that either port may function as an inlet port whilst the other port functions as an outlet port. A flow passage 17 is in part defined within the valve body to provide communication between the ports 15 and 16. A diaphragm opening 18 is defined by the valve body. In use, the diaphragm opening 18 is closed by a flexible closure diaphragm the diaphragm accordingly partly defines the flow passage.

The diaphragm opening 18 is surrounded by a sealing surface 19 against which the periphery of the diaphragm is, in use, sealed. The diaphragm sealing surface 19 is generally planar but may include surface profile features (for example one or more ridges or grooves) in order to assist the formation of a fluid tight seal between the diaphragm and the sealing surface. As will be appreciated by those skilled in the art, when the diaphragm is in position and sealed to the sealing surface 19 the flow passage 17 is entirely defined by the valve body and the diaphragm and line content will not come into contact with any other components of the valve.

The valve body 11 defines a weir 20 the upper surface of which defines a seat 21. The operating mechanism which is used with the valve body is capable of forcing the diaphragm into sealing engagement with the seat 21 in order to close the flow passage 17 to fluid flow. Preferably, the operating mechanism is also capable of moving the diaphragm away from the seat 21 so that the valve may be open to fluid flow even if the line content is at sub-ambient pressure.

The sealing surface 19 is surrounded by a wall 22. In the illustrated embodiment the wall 22 is cylindrical, the surface of the wall 22 at any point being perpendicular to the adjacent portion of the sealing surface 19. The sealing surface 19 and wall 20 accordingly define a recess 25 in which the periphery of the diaphragm is, in use, located.

Referring now to FIG. 12, a diaphragm retaining member 23 is, in use, secured to the valve 11 to retain the diaphragm and hold the diaphragm in sealing engagement with the sealing surface 19. The diaphragm retaining member 23 includes a projection 24 which is a snug-fit within the recess 25 defined by the valve body. The diaphragm retaining member 23 also includes an outwardly projecting flange 26 which engages a corresponding flange 27 provided on the valve body. The components are sized such that when the flanges 26 and 27 are in contact with each other the spacing between the free end 28 of the projection 24 and the sealing surface 19 is correct relative to the thickness of the diaphragm to ensure the required sealing contact and mechanical support of the diaphragm relative to the valve body. Preferably, the projection 24 includes a chamfered surface 29 so that the projection 24 and body 11 together defined an undercut region at the outer periphery of the diaphragm. Preferably, the diaphragm is moulded with a projection corresponding to the undercut region so that the periphery of the diaphragm is mechanically clamped against radially inward movement.

The seal between the diaphragm and the sealing surface 19 may be produced purely by resilient deformation of the material of the diaphragm against the sealing surface 19. However, it is within the scope of the invention for positive sealing at this point to be effected by use, for example, of an adhesive or sealing compound or by welding of the material of the diaphragm to the valve body.

Similarly, the diaphragm retaining member 23 may be secured to the valve body 11 solely by mechanical clamping or may be secured additionally or exclusively by means of adhesive or welding. The object, in all cases, is to provide a disposable assembly which may comprise the valve body 11 and the diaphragm only or may comprise the valve body 11, the diaphragm and the diaphragm retaining member 23. In all cases, means will be provided for releasably securing an operating mechanism to the disposable assembly so that, when the assembly is to be disposed of, the operating mechanism may be retained and secured to the replacement assembly.

Referring now to FIGS. 5-7 various releasable arrangements for securing a diaphragm retaining member to a valve body are illustrated.

Referring firstly to FIG. 13, the illustrated diaphragm retaining member 30 is secured to a valve body 31 by means of clamps 32 which engage projections 33, 34 on the diaphragm retaining member 30 and valve body 31 respectively. The projections 33, 34 and/or the clamps 32 define tapering surfaces such that as the clamps 32 are pushed onto the projections 33, 34 the diaphragm retaining member 30 and body 31 are brought into the required relative position. The clamps 32 may be releasable or may be locked in their final position by mechanical detents, adhesive, welding, or the like. As illustrated, one clamp 32 is provided on each of two opposite sides of the valve body. However, other arrangements are possible. For example, clamps can be provided on all four faces of the valve body. Further, rather than one large clamp two or more small clamps can be provided on some or all of the sides.

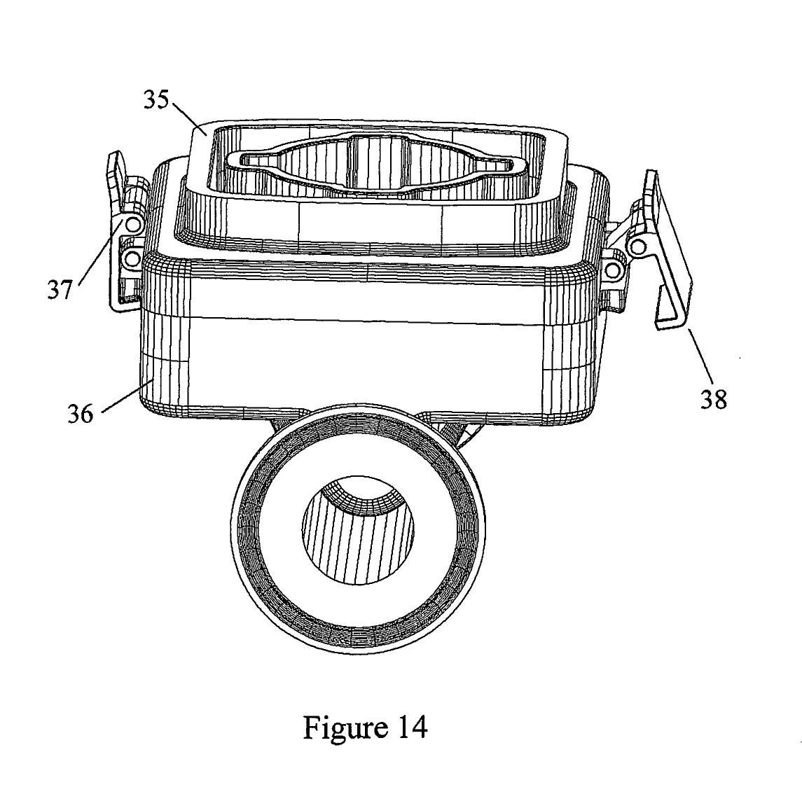

Turning now to FIG. 14 the diaphragm retaining member 35 is secured to the body 36 by over-centre toggle clamps 37,38. As with the arrangement of FIG. 13, clamps may be provided on two only of the sides of the diaphragm retaining member or on all four sides and one, two or more clamps may be provided on one or more of the sides according to the particular design required.

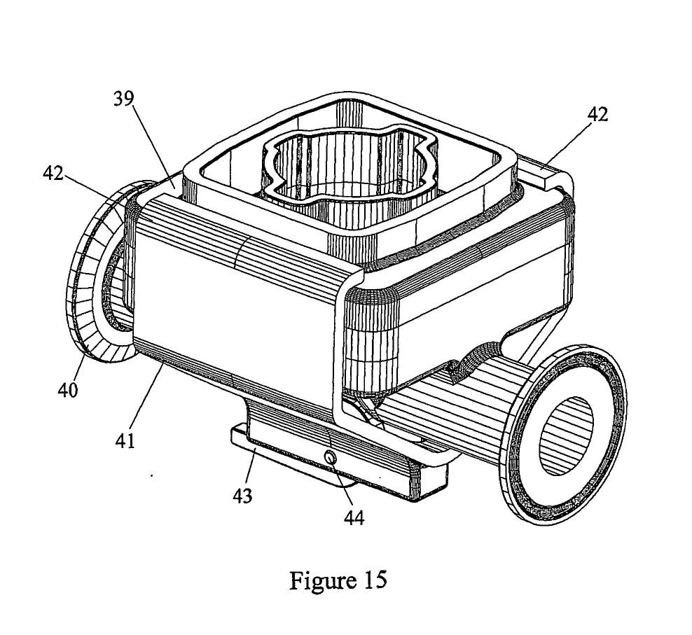

Referring now to FIG. 15, the diaphragm retaining member 39 is secured to the valve body 40 by a saddle clamp 41 which includes projections 42 which overlie an upper surface of the diaphragm retaining member 39 and a cam-lever 43 which may be rotated about a pivot pin 44 to engage the under surface of the valve body 40 and thereby draw the diaphragm retaining member 39 into the required position relative to the valve body.

Referring now to FIG. 16, an alternative arrangement is illustrated. In this arrangement a valve body 45 similar to that illustrated in FIG. 11 is used, but no separate diaphragm retaining member is utilised. Instead, the operating mechanism 48 acts as a diaphragm retaining member and the valve body 45 is formed with bayonet slots 46 which are engaged by bayonet pins 47 provided on the bottom of an operating mechanism 48. In this case, the operating mechanism 48 is released from the valve body/diaphragm assembly by rotating the operating mechanism 48 relative to the valve body to release the bayonet pins 47 of the operating mechanism from the corresponding bayonet slots 46 of the body. After the body has been replaced, the operating mechanism is secured to the replacement body by a reversal of this procedure.

Referring now to FIG. 17 a diaphragm 50 suitable for use in the previously described embodiments of the invention is shown. The diaphragm is formed of a flexible and extensible material so that it can be moved by the operating mechanism as required by the valve design. Generally, the diaphragm 50 will be formed of an elastomeric/polymeric material, possibly with the addition of fibre or fabric reinforcement. The diaphragm may be faced with a chemically resistant facing, for example of a fluorocarbon polymer. The periphery 51 of the diaphragm closely matches the diameter of the recess 25. The peripheral region 52 of the underside of the diaphragm in use forms a seal with the sealing surface 19. The region 52 may be generally planar or may be formed with surface features to enhance sealing. The peripheral region 53 of the upper surface of the diaphragm includes a projection 54 which is complementary to the chamfer 29 provided on the diaphragm retaining member. A stud 55 is moulded into the central region of the diaphragm to provide a mechanical connection between the diaphragm and the compressor of the operating mechanism. The stud 55 may be provided with any appropriate form of mechanical connection to the compressor. Instead of a moulded in stud 55, a specially shaped portion of the material of the diaphragm may, in the alternative, be provided to facilitate mechanical connection between the diaphragm and the compressor.

Whilst the invention has been described in the context of a 2-port valve it is to be understood that the present invention is applicable to other forms of valve, for example valves with three or more ports controlled by one or more diaphragms. The exact arrangements of the valve body, diaphragm and operating mechanism will, of course, be determined by the number of ports present in the valve, but the general concepts of the present invention may be applied to such multi-port valves and the present application is to be construed as encompassing such multi-port valves.

1. A diaphragm valve (1) comprising: a valve body (2); a diaphragm (12) which is sealed to the valve body (2) to define a flow passage (9) which extends between an inlet port (7) and an outlet port (8), both defined by the valve body (2); and an operating mechanism secured to the valve body (2) for moving the diaphragm (12) into sealing engagement with a valve seat (11) provided on the valve body (2) in order to close the flow passage (9) to fluid flow, characterised in that the valve body (2) and diaphragm (12) are integrally formed as a disposable assembly having a relatively less flexible region with a weir extending across the passage (9) which forms the valve seat (11) and a relatively more flexible region (12) which forms the diaphragm which may be forced into engagement with the valve seat (11) to close the flow passage (9) to fluid flow, and a housing (3) is provided for mechanically supporting the region of the valve body in which the seat area is defined.

2. A diaphragm valve (1) according to claim 1, wherein said housing (3) has a longitudinal through opening formed therein in which at least the region of the valve body in which the seat area is defined in mounted so as to support said region.

3. A diaphragm valve (1) according to claim 1, wherein said housing includes an aperture in the region of the diaphragm (12) in which said operating mechanism engages.

4. A diaphragm valve (1) according to claim 1, wherein said housing is formed by an upper support member (4) having a lower surface which engages an upper surface of said region of the valve body, and a lower support member (5) having an upper surface which engages a lower surface of said region of the valve body, said upper and lower surfaces of said support members (4, 5) being of complementary shape to the respective upper and lower surfaces of the said region.

5. A diaphragm valve (1) according to claim 4, wherein said support members (4, 5) define between each other a through opening through which said valve body extends.

6. A diaphragm valve (1) according to claim 1, wherein the region of the valve body (2) in which the seating area is defined has an upper wall and a lower wall, the upper wall being flexible and forming the diaphragm (14), and the lower surface being rigid and its inner surface forming the valve seat (11).

7. A diaphragm valve (1) according to claim 6, wherein said upper wall is thinner than said lower wall so as to be more flexible.

8. A diaphragm valve (1) according to claim 6, wherein said upper wall is of a different shape to said lower wall such that said upper wall is more flexible than said lower wall.

9. A diaphragm valve (1) claim 6, wherein said lower wall includes reinforcing means which increases its stiffness.

10. A diaphragm valve (1) according to claim 6, wherein said upper wall is formed of a more flexible material than said lower wall.

11. A diaphragm valve (1) according to claim 1, further including a pair of wings (13, 14) which extend laterally outwards from opposite sites of the valve body in the region of the valve seat.

12. A diaphragm valve (1) according to claim 11, where said wings (13, 14) extend longitudinally along the valve body and taper laterally towards said valve body (2) towards each end thereof so as to have a maximum width in the region of the valve seat (12).

13. A diaphragm valve (1) according to claim 1, wherein the diaphragm (12) is formed separately to and is sealingly welded to valve body (2), in particular by welding.

14. A diaphragm valve (1) according to claim 1, wherein the diaphragm (12) is formed of a different material or different grade of material, in particular a different polymer or different grade of polymer, than at least the region of the valve body (2) which forms the valve seat (11).

15. A diaphragm valve (1) according to claim 1, wherein said housing (3) includes marking means which permanently marks the valve body upon mounting of the valve body therein so as to identify the valve body as having been used.

16. A diaphragm valve (1) according to claim 16, wherein marking means damages said valve body so as to prevent its reuse.

17. A diaphragm valve (1) according to claim 1, wherein said operating means (32) is mechanically coupled to said diaphragm such that upon movement of the operating means (32) towards the valve seat the diaphragm (12) is pressed by the operating means (32) against said valve seat (11) and upon movement of the operating means (32) away from the valve

18. A diaphragm valve (1) according to claim 17, wherein a coupling means, in particular a cup (40), is formed, in particular integrally formed, on said diaphragm (12), which couplingly engages, in particular is a snap fit, with complementary coupling means, in particular a button (42) carries on the operating means (32).

19. A diaphragm valve (1) according to claim 18, wherein said diaphragm (12) is coupled to the operating means (32) in such a manner that the coupling means formed on the diaphragm is damaged upon uncoupling the diaphragm from the operating means (32), thereby prevent reuse of the valve body (2).

20. A diaphragm valve (1) according to claim 1, wherein the valve body is profiled to include a flat invert surface (24) extending through the body from the inlet port (7) to the outlet port (8) such that the valve body is self draining.
